(19) United States
(12) Patent Application Publication
(10) Pub. No.: US 2008/0121764 A1
(43) Pub. Date: May 29, 2008

(54) Line Block Supports and Methods and Apparatus for Making and Using and Reconfiguring for Alternate Sizes of Payload Line Block Supports

(76) Inventors: Igor Komsitsky, Los Angeles, CA (US); Javier Torres, Hacienda Heights, CA (US)

Correspondence Address: HENRICKS SLAVIN AND HOLMES LLP;SUITE 200, 840 APOLLO STREET, EL SEGUNDO, CA, 90245, US

(21) Appl. No.: 11/864,893

(22) Filed: Sep. 28, 2007

Related U.S. Application Data
(60) Provisional application No. 60/827,604, filed on Sep. 29, 2006.

(51) Int. Cl. F16L 3/02

(52) U.S. Cl. 248/74.3

(57) ABSTRACT

Line supports are described that can have more flexible applications or uses, or they can be used with a wider range of payload configurations. For example, line supports are described that can accommodate a larger number of payload sizes, or that can be reconfigured from one payload size combination to another payload size combination, for example without replacing the part. Methods are also described.

### CROSS REFERENCE TO RELATED APPLICATIONS

This application claims benefit of priority to U.S. Provisional Patent Application Ser. No. 60/827,604, filed Sep. 29, 2006, incorporated herein by reference.

### BACKGROUND

1. Field

This relates to supports, for example for lines, tubes, cables, conductors and other elements, for example line support blocks, tubes support blocks, block clamps and similar structures.

2. Related Art

Line support blocks are silicone rubber or other rubber or other elastomeric or non-metallic structures having openings there through for receiving and supporting lines, cables, hydraulic tubes and other pass-through elements (referred to herein generically as “payload”). Line support blocks may come in a number of outer shapes, often conforming to the shape of an opening into which the line block is placed and secured. Line blocks can also have basic outer geometric shapes, such as square, rectangular, trapezoidal, round or combinations of shapes.

Line support blocks often include one or more than one opening through the block, to accommodate more than one payload. The size and shape of each opening is determined by the outside dimension and shape of the payload. Therefore, different line support blocks will be made to accommodate different sizes of payloads, and even more line support blocks may be needed when the size and shape of an opening for one payload is different than that for another payload. Additionally, line support blocks may need to be specially manufactured to accommodate the different sizes and number of payloads to be used at a particular location in a structure, for example in an aircraft or ship frame or other applications. With the larger number of configurations, the number of parts for inventory increases, and the number of different parts that a user may need to order or stock also increases.

### SUMMARY

Line supports are described that can have more flexible applications or uses, or they can be used with a wider range of payload configurations. For example, line supports are described that can accommodate a larger number of payload sizes, or that can be reconfigured from one payload size combination to another payload size combination, for example without a need for replacing the part. Methods are also described.

In one example of a payload support, the support structure may be configured to have a first wall for defining an opening for receiving a payload. At least part of the opening will have a first shape or first profile, for example arcuate, straight, angled, curved, or other shape. One or more other openings are formed in or through the support structure outward of the payload opening. By removing material from the structure between the payload opening and the one or more other openings, the payload opening can be made to have a different configuration, such as larger, a different shape, or both larger and a different shape, a different profile, or otherwise. In one example, the one or more other openings have a shape that is the same as or similar to the first shape of part of the opening. For example, where the payload opening is circular, part of the payload opening has a shape that is in part circular or arcuate. The shapes of the one or more other openings can also be partly circular or arcuate, and in one example, they have the same profile as the first profile. In another example, where the payload opening is triangular, the shape of part of the payload opening can be angular or can be straight, depending on which portion of the triangular payload opening is selected.

In another example of a payload support, the support structure may be configured to have one or more first openings that can be used to define a first payload opening, for example having a first size or first shape. One or more second openings are also formed in the support structure outward of the first openings, with support material in the area between the first openings and the second openings. In one configuration, the payload support can accommodate a first payload having a first configuration when the support structure interior to the first openings is removed, thereby forming the first payload opening (for example, having a first diameter). In another configuration, the payload support can accommodate a second payload having a second configuration (for example, having a larger diameter) by removing the material within the first opening and removing the material between the first opening and the second openings. In another example, third openings can be formed in the support structure outward of the second openings, and fourth and more openings can be formed outward of the third openings, thereby allowing configurations for accommodating larger payloads.

In a further example of a payload support, the support structure may be configured to have one or more first openings that can be used to define a first payload opening, for example having a first size or first shape. One or more second openings are formed in the support structure outward of the first openings, with support material in the area between the first openings and the second openings. The payload support can be used to support a first payload for a time in the first payload opening, and then the material between the first payload opening and second openings can be removed to support a second payload, for example having a larger diameter, thereafter.

In an additional example of a payload support, a support structure may be configured to have one or more first openings, slits or cuts defining a first region interior to the first openings. The material within the first region can be removed to define a first payload support opening. The material within the first region can be removed at the factory or in the field. The support structure may also be configured to have one or more second openings, slits or cuts defining a second larger region interior to the second openings. The material between the second openings on the outside and the first openings on the inside can be removed to define a second payload support opening larger than the first payload support opening. In one example, the one or more first openings define a circular opening having wall portions that are arcuate or follow a circular path. Each of the one or more second openings are also arcuate or follow portions of a circular path. When the material interior to the second openings is removed, a circular payload support opening is formed. One or more third openings can be formed outward of the one or more second openings, and so on, for allowing selective formation of different payload support configurations.

In any of the examples described herein, the payload support can be considered to have an outer perimeter surface. The outer perimeter surface may take any shape. An access slit or cut may be formed in the payload support extending from the outer perimeter surface to one of the outer openings, one of the second openings, and/or one of the first openings. The access slit may be used to insert the payload into the payload support opening defined by removing material from within the first openings, from within the second and first openings, from within the third, second and first openings, or otherwise.

In a further example, a support for a payload or other component passing from a first side of the support to a second side of the support includes a surrounding structure having an outer perimeter surface. A first inner wall defines a first opening with at least a part of the first opening having a first shape. A second inner wall defines a second opening or breach into or through the surrounding structure, positioned between the first inner wall and the outer perimeter surface, and having first and second sides separable from each other a first distance and wherein the first side has a length, for example an arc length, greater than the first distance and having a relaxed shape similar to the first shape. A third inner wall defines a third opening or breach into or through the surrounding structure, positioned between the first inner wall and the outer perimeter surface, and the third inner wall is unconnected to the second inner wall, and the second inner wall has third and fourth sides separable from each other a second distance and wherein the third side has a length greater than the second distance and has a relaxed shape similar to the first shape. The shape may be arcuate or partly circular or may be another shape. The first inner wall is interior to the second inner wall, which in turn is interior to the third wall, and so on.

In another example, a method of making a payload support element includes forming one or more first openings defining a first interior area having a first size for receiving a first payload. One or more second openings are formed outward or outboard of the one or more first openings, and as to which removal of all the material interior to the one or more second openings forms a second interior area having a second size for receiving a second payload having a configuration different from the first payload. In one example, the one or more first openings is a single, first circular opening and the second openings are arcuate slits or cuts formed in the payload support element outward of the first circular opening. If the payload support material between the second openings and the first circular opening is removed, a second circular opening may be formed having a diameter larger than the first circular opening. The second circular opening can then support a payload having a different configuration (for example, different diameter) than that accommodated in the first circular opening. In another example, one or more third openings and additional sets of openings may be formed outward of the third and each respective additional set of openings, and removal of the intervening material can form a payload opening for accommodating a payload having a different configuration. A slit or cut can also be formed to extend from an outer perimeter of the payload support element to one or more of the first, second or other openings. Each of the one or more openings can be formed by mechanical cutting, water jet cutting or by other methods.

In a further example of a method of making a payload support element, any of the methods described above can be used to produce a payload support having a desired configuration. Additionally, further first, second and additional sets of openings can be formed to provide an additional area for supporting a second or additional payload. The first payload configuration can be identical to or different from the configuration of the second or additional payload. The opening for the first payload can be formed by removing material from the payload support element interior to the first opening, interior to the second openings, interior to the third openings or to any additional openings. The opening for the second payload can be formed by removing material from the payload support element interior to the first, second, third or additional openings corresponding to the second payload support opening. Additional payloads can also be accommodated by forming appropriate sets of openings and selectively removing material sufficient to accommodate each additional payload.

In an additional example, a payload is supported by a payload support element by forming an opening for accommodating a particular payload configuration. The opening is formed by removing material interior to a plurality of pre-existing openings in the payload support element. The payload is then positioned in the opening. In one example, the opening is formed by removing arcuate sections of material to form a circular opening. In another example, the opening is formed by punching out one or more sections of material to form a payload opening. In another example, different size payloads can be supported by the same payload support element by removing material from a first region interior to a plurality of pre-existing openings in the payload support element, and removing material from a second region interior to a second plurality of pre-existing openings.

These and other examples are set forth more fully below in conjunction with drawings, a brief description of which follows.

### BRIEF DESCRIPTION OF THE DRAWINGS

FIG. 1 is a front elevation view of one example of a line support block.

FIG. 2 is a side elevation view of the line support block shown in FIG. 1.

FIG. 3 is a top plan view of the line support block shown in FIG. 1.

FIG. 4 is a detailed and exploded view of one region of the line support block of FIG. 1 showing openings through the support block.

FIG. 5 is an exploded view of an opening in the region of the line support block of FIG. 4 showing an arc length and an opening width.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of supports and of methods of making and using the supports are described. Depending on what feature or features are incorporated in a given structure or a given method, benefits can be achieved in the structure or the method. For example, the supports described may allow more flexibility in assembly and installation of components, for example in aircraft, and the like.

In some configurations of supports, improvements can be achieved also in assembly, and in some configurations, a relatively small number of support structures can be used to provide a larger number of configurations of supports. For example, a single support may be configured to accommodate a large number of payloads, such as by selectively removing material to change a particular opening configuration to another configuration.

These and other benefits will become more apparent with consideration of the description of the examples herein. However, it should be understood that not all of the benefits or features discussed with respect to a particular example must be incorporated into a component or method in order to achieve one or more benefits contemplated by these examples. Additionally, it should be understood that features of the examples can be incorporated into a component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of support configurations and of methods of making and using the supports are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

Circular tube supports are used as examples of a line support block that can incorporate one or more of the features and derive some of the benefits described herein. However, supports other than those described herein can benefit from one or more of the present inventions.

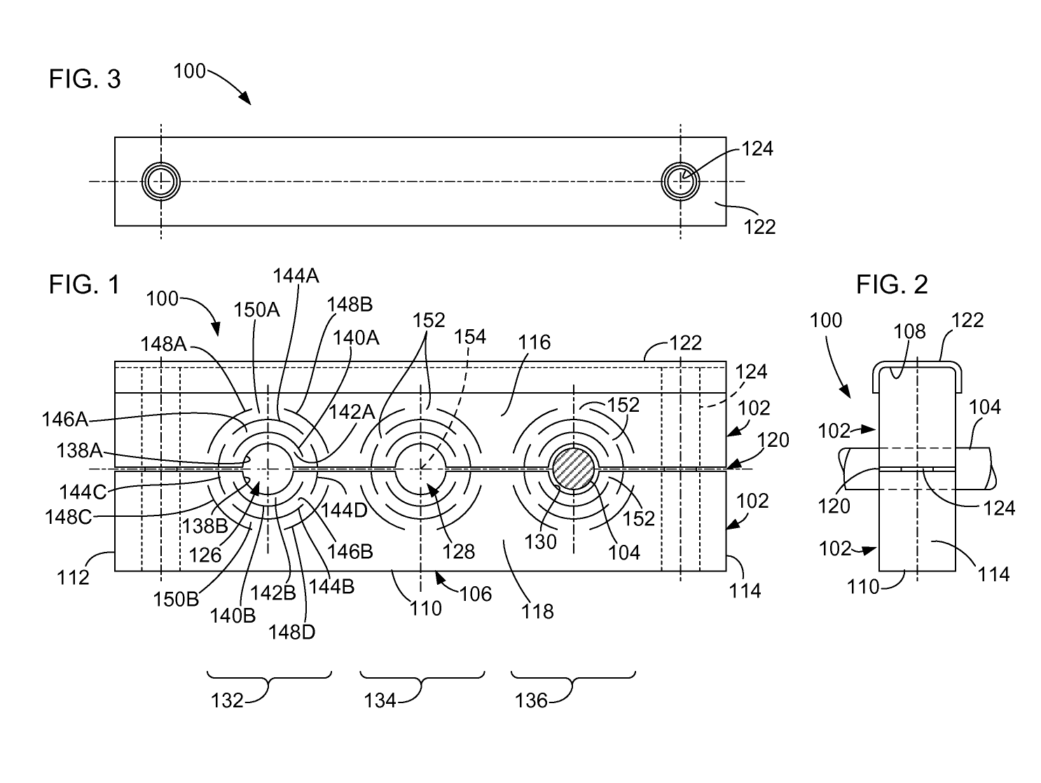

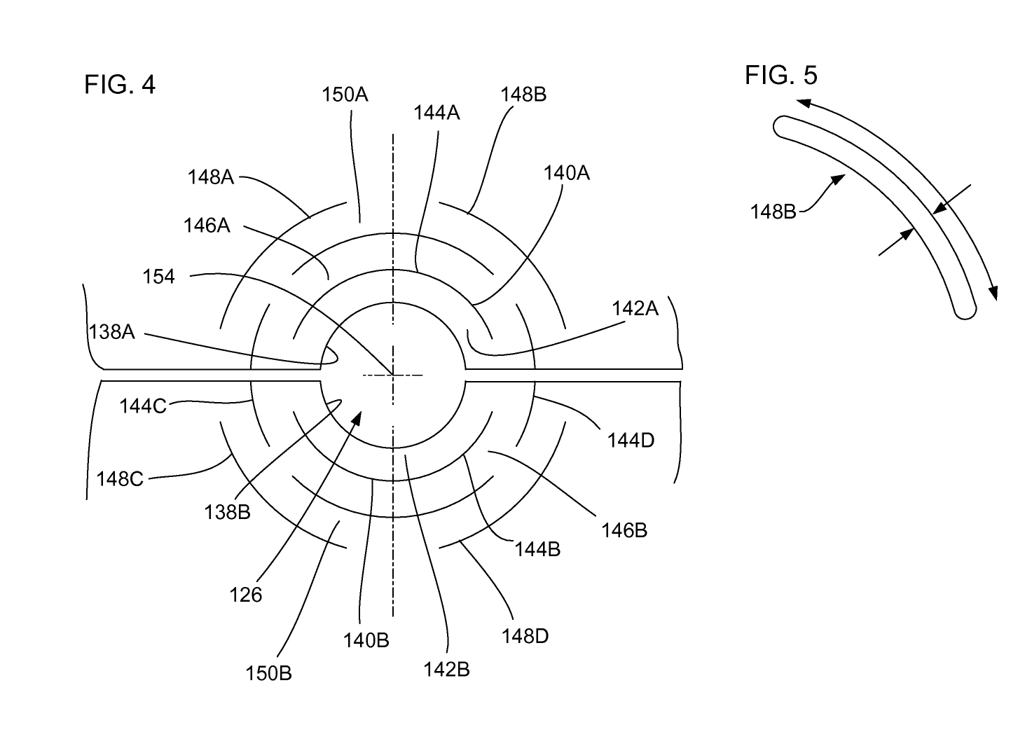

Payload supports can take a number of configurations, but one example will be discussed in the context of a line support block with respect to FIGS. 1-3 for purposes of providing an example of the structures that can incorporate one or more aspects of the inventions. In the example, a line support block 100 includes a support structure 102 for receiving one or more payloads, represented at 104 in FIGS. 1-2. The payload 104 is represented as being smaller in outside diameter than the inside diameter of the corresponding opening, but it should be understood that the respective outside and inside dimensions are nominally the same in many support combinations. In the present example, the support structure 102 includes an outer perimeter 106 defined by the top 108, bottom 110 and left 112 and right sides 114 as the structure is viewed in FIGS. 1-2. It should be understood that the location terminology is used only for purposes of discussion and identification of elements as they are viewed in the drawings, and are not intended to describe actual locations or orientations during installation or use.

In the configuration shown in the drawings, the support structure 102 is cut, formed or otherwise made into an upper block 116 and a lower block 118. Adjacent surfaces of the upper block 116 and the lower block 118 contact each other along a slit, cut, gap or contact area 120, along an approximate mid-horizontal plane of the support structure 102. In the present example, the line support block includes a U-channel 122 (FIGS. 1-3), typically formed of metal, plastic, wood or other support material, and one or more anti-compression tubes 124. The structure and function of the U-channel 122 and the anti-compression tubes 124 are conventional for line support blocks. The U-channel may be used on both the top and the bottom of the line support blocks.

The support structure 102 (FIG. 1) includes a plurality of openings formed in the support structure 102 for use in defining a number of support openings for receiving respective payloads. The support openings can take a number of configurations, including a number of sizes and a number of shapes and they may pass completely through the respective upper or lower blocks or only part way. However, for purposes of the present example, only circular shapes will be discussed, but it should be understood that other shapes can be used. A support opening will be an opening configured to receive and support a payload as desired. In FIG. 1, three support openings 126, 128 and 130 are shown as all being circular in shape and all having the same dimension, namely the same diameter. However, any support opening can take any desired shape or size, and any support structure can accommodate support openings having different shapes and/or sizes between one and another. The first support opening 126 is formed in a region 132 of the support structure 102, the second support opening 128 in a second region 134 and the third support opening 130 is formed in a third region 136. The support openings and the other openings within a given region can be the same or different from those of another region in the support structure. However, the present description will be directed primarily to a single region, namely the first region 132.

The first support opening 126 is depicted in FIG. 1 as being open and lacking any material interior to the opening 126. However, it should be understood that the first support opening 126 can be formed by cutting or punching the material out from the interior of the wall defining the opening 126 in a manner similar to that discussed below with respect to the creation of larger support openings in the region 132. Therefore, the first support opening 126 can be formed at the factory or in the field.

The first support opening 126 includes a first wall 138A for partly defining an opening for receiving a payload. At least part of the wall, and in the present example shown in FIG. 1 all of the wall 138, has a circular or arcuate shape. The support opening 126 also includes first wall 138B for partly defining the opening for receiving the payload. The first wall 138A is in the upper block 116 and the wall 138B is in the lower block 118, but when the upper and lower blocks are joined, the first walls 138A and 138B substantially form a circle.

A second plurality of openings are also formed in the support structure outward of the first walls 138A and 138B, with support material in the area between the first walls and the second openings. Specifically, an upper second opening 140A and a lower second opening 140B are formed in the support structure of the first region 132, each outward of respective first walls 138A and 138B. Additionally, the upper second opening 140A and the corresponding first opening 138A define between them a segment of material 142A, and lower second opening 140B and the corresponding first opening 138B define between them a segment of material 142B. Therefore, the payload support 100 can accommodate a first payload (such as circular payload 104) when the support structure interior to the first walls 138A and 138B is removed, thereby forming the first payload opening 126, having the diameter presented by the walls 138A and 138B. In another configuration, the payload support 100 can accommodate a second payload having a second configuration (for example, having a larger diameter) by removing the material within the first walls 138A and 138B, as well as the material between the first walls and the second openings 140A and 140B. Specifically, the segments 142A and 142B can also be removed, in addition to the material interior to the first walls 138A and 138B, to accommodate and support a second, larger diameter payload.

A third plurality of openings are also formed in the support structure outward of the second plurality of openings 140, and therefore also outward of the first walls 138A and 138B, with corresponding support material in the area between the third plurality of openings and the second plurality of openings. Specifically, an upper third opening 144A and a lower third opening 144B, as well as a left third opening 144C and a right third opening 144D, are formed in the support structure of the first region 132. Each of the third openings 144 is outward of adjacent second openings 140. Additionally, the upper third opening 144A and portions of the left and right third openings 144C and 144D, respectively, in the upper block 116 and the upper second opening 140A define between them a segment of material 146A. The lower third opening 144B and portions of the left and right third openings 144C and 144D, respectively, in the lower block 118 and lower second opening 140B define between them a segment of material 146B. Therefore, with the configuration of the first, second and third openings in the first region 132, the payload support 100 can accommodate the first payload such as circular payload 104 when the support structure interior to the first walls 138A and 138B is removed, forming the first payload opening 126. As discussed above, the first payload opening 126 has the diameter presented by the walls 138A and 138B, and if the material between the first walls and the second openings 140A and 140B are removed, such as by removing the segments 142A and 142B, the payload support 100 accommodates a second payload having a second configuration such as a larger diameter corresponding to the inside diameter defined by the outer walls of the openings 140A and 140B. Furthermore, the material interior to the third openings 144 can be removed by removing the segments 146A and 146B to accommodate a third payload configuration such as that having a larger diameter corresponding to the inside diameter defined by the outer walls of the third openings 144.

The fourth plurality of openings are also formed in the support structure outward of the second and third plurality of openings, with corresponding support material in the area between the fourth and third plurality of openings. Specifically, an upper left fourth opening 148A and an upper right fourth opening 148B, and a lower left fourth opening 148C and lower right fourth opening 148D are formed in the support structure of the first region 132. Each of the fourth openings 148 is outward of adjacent third openings 144. Additionally, the fourth openings 148 in the upper block 116 and the adjacent third openings define between them a segment of material 150A. The fourth openings 148 in the lower block 118 and the adjacent third openings define between them a segment of material 150B. Therefore, with the configuration of the first, second, third and fourth openings in the first region 132, the payload support 100 can accommodate the first payload such as the circular payload 104 in a first payload opening 126. A second payload configuration can be received and supported by removing the segments 142, a third payload configuration can be received and supported by removing the segments 146, and a fourth payload configuration can be received and supported by removing the segments 150.

As shown in FIG. 1, each region 134 and 136 has an identical set of openings formed in the region as the openings discussed above with respect to region 132. Therefore, the payload support can receive and support a plurality of payloads, each having the same configuration or a different configuration from that of the others. As shown in FIG. 1, each region will accept a payload having a generally circular outer configuration, but it should be understood that the openings in each region can be formed as desired to receive and support a payload having the desired configuration. In any case, payloads of a given shape though of different sizes can be received and supported in the payload support, depending on the segments removed from a given region.

In the configuration of the payload support shown in FIG. 1, it is understood that one or more or all of the openings 126, 128 and 130 can be filled with respective half-circle segments (not shown) separated along the gap 120 until such time as a payload such as payload 104 is to be inserted into the respective opening. In this way, circular openings (as shown in FIG. 1, or other shaped openings in other configurations) such as 126, 128 or 130 are established only when used, and they can remain occupied with their respective segments otherwise.

In some examples of payload supports configured in ways described herein, the segments form spacer elements. They space the payload the desired distance from the underlying support surface or from outer edges of the payload support. When such spacer elements are in place, they also space the payload the desired distance from the outer-most openings, such as openings 148A, 148B, 148C and 148D. The segments may also be considered filler elements, packing elements or support elements. In an example of filler elements, the elements fill the space between the opening on the outer surface of the respective element and the inner surface of that element. For example, the segment 146A fills the space between the opening 144A on the outside and the opening 140A on the inside. In an example of packing element, for instance, the segment provides packing between the adjacent outer opening and the adjacent inner opening. For example, the segment 146A packs the space between the opening 144A on the outside and the opening 140A on the inside. Also, if the payload outside dimension is larger than the inside dimension of the opening in which it is held, pressure from the packing elements helps to hold the payload in place. For the present discussion of present examples, the elements will be referred to as segments.

In the configuration of a payload support such as that described with respect to FIG. 1, the payload support can be used to support a first payload, for example having a given size, for a period of time. Thereafter, if a larger payload is desired to be used in place of the first payload, segments can be removed and the larger payload placed in the larger opening formed by removing the additional segments. In the context of FIG. 1, the payload 104 can be replaced with a larger payload by removing the segments 142. The number of segments removed will be determined by the outer dimension of the payload to be supported.

Individual segments are held in place by linking or bridging material, webs or tabs 152 (FIG. 1) until the segment is removed. For any set of segments a given distance from a center, such as center 154, there may be an even number of tabs holding the segments in place. For example, there are four tabs holding the segments 142 in place, four tabs holding the segments 146 in place and six tabs holding the segments 150 in place. Other tab numbers are possible, but there is preferably at least one tab for each segment. The distribution of the tabs shown in FIG. 1 is substantially uniform about the center 154, for the respective region, and the orientation of the tabs is substantially radial. However, the distribution and orientation of the tabs can be selected as desired. When segments are removed, tabs are also preferably removed so the surface defining the opening receiving a payload is substantially smooth. However, projections can be left in place, depending on how the segments are removed.

Within a given payload support region, the openings and the corresponding segments are preferably arranged to be concentric about a center, for example center 154. In the example shown in FIG. 1, the openings and the corresponding segments are concentric about the center 154, and the payload openings that can be formed would also be concentric about the center. Other configurations of payload openings are also preferably, but need not be, concentric.

In the example shown in FIG. 1, four different opening sizes are provided for each payload support region. In one example, the possible opening diameters for a round payload can be ½ inch, ¾ inch, one inch, and 1¼ inch. The width of the various openings 140, 144 and 148 (see, for example, opening 148B in FIG. 5) may depend on how the openings are formed, but the width can vary for example from 0.01 in. to a sixteenth inch spacing or more. Where the openings are formed with a water jet or other high precision cutting technique, the width of each opening may be the minimum possible for the given technique. The openings are formed completely through the thickness of the upper and lower blocks 116 and 118, respectively, (from left to right or from right to left in FIG. 2) but they need not extend completely through. For example, a thin web of material may be left during the cutting process that can be easily removed when the segments are removed to form an alternative support opening.

The openings can have configurations other than arcuate as shown in FIG. 1. For example, each opening can be straight, angled or smoothly curving, or other configuration. The possible payload openings can be circular, triangular, oval, square, rectangular, hexagonal, other uniform geometric shapes or a non-uniform shape. The combination of openings and tabs that can be used to form a payload opening can be determined by the outer configuration of the particular payload to be supported. Payloads can range from less than or equal to ¼ inch up to greater than or equal to three inches, but a typical range may be between ¼ and three inches. The line support block may be any suitable thickness, the maximum for which may be determined by the cutting method for the openings forming the payload openings. The outer perimeter 106 of the payload support can also take a number of configurations.

The payload support blocks 116 and 118 can be formed from any suitable material, including those presently used for line support blocks. Materials may include plastic, including elastomeric materials, Neoprene, silicone, Teflon, other plastics, composites, wood, other non-metals, and other materials softer than metal. While metal can be used, non-metal materials are appropriate for many applications.

Segments can be removed to form larger payload openings using a suitable tool. For example, tubes with sharpened openings corresponding to the diameter of the desired payload can be used to remove segments. Typically a combination of tubes corresponding to the number of payload openings will be available to remove the segments to thereby form the openings. The tubes can be combined into a combination tool, with the tubes mounted concentrically.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. A payload and payload support combination comprising:
a first payload block portion and a second payload block portion placed against each other and defining between them a payload opening;
a payload positioned in the payload opening;
a holding structure holding the first and second payload block portions on a support structure;
a first wall defining a first passageway through the first payload block portion wherein the first wall is positioned between the payload opening and a surface of the first payload block portion opposite the payload opening and defining in the first payload block portion a first segment supported by a removable support material connecting the first segment to the second payload block portion; and
a second wall defining a second passageway through the second payload block portion defining in the second payload block portion a second segment supported by a removable support material connecting the second segment to the second payload block portion.

2. The combination of claim 1 wherein the first and second passageways are arcuate.

3. A payload support comprising:
a first payload block portion having a first surface and having a second outer surface for being supported against a first support structure and a payload second block portion having a third surface facing the first surface of the first block portion;
a segment in the first block portion supported in the first block portion between the second block portion and a first wall defining an opening in the first block portion and wherein the first payload block portion and the segment are configured so that the segment is removable from the first payload block portion without damaging the first payload block portion; and
at least one mounting element for mounting the first and second block portions to the first support structure.

4. The support of claim 3 wherein the segment is a first segment and further including a semi-circular segment in the first block portion and having a segment surface forming part of the first surface of the first payload block portion and facing the third surface of the second block portion.

5. The support of claim 4 wherein the first segment includes first and second arcuate surfaces.

6. The support of claim 3 wherein the segment is a first segment and further including a plurality of segments, and wherein at least two of the segments have arcuate surfaces.

7. The support of claim 3 wherein the segment is a first segment and further including a plurality of segments, and wherein at least some of the plurality of segments are concentric.

8. The support of claim 3 wherein the segment has a first width and the opening in the first block has a second width substantially smaller than the first width.

9. The support of claim 3 wherein the first and second payload block portions are either integral with each other or separate block portions.

10. The support of claim 3 further including a first plurality of removable segments including the first segment such that removal of at least one of the first plurality of removable segments forms a first opening in the first block portion, and further including a second plurality of removable segments such that removal of at least one of the second plurality of removable forms a second opening in the first block portion spaced apart from the first opening.

11. The support of claim 3 further including a first plurality of removable segments including the first segment such that removal of one of the first plurality of removable segments forms a first opening in the first block portion having a first cross-sectional area, and such that removal of two of the first plurality of removable segments forms a second opening in the first block portion having a second cross-sectional area.

12. The support of claim 3 wherein the segment is a first segment and further including a plurality of removable segments in the first block portion including the first segment and a plurality of walls defining respective openings in the first block portion, and wherein at least two of the walls form respective parts of a circle.

13. The support of claim 12 wherein the circle is a first circle and further including at least two additional walls forming respective parts of a second circle concentric with the first circle.

14. The support of claim 3 wherein the segment is a first segment and further including a plurality of segments including the first segment wherein each of the plurality of segments is arcuate, and wherein a first group of segments in the plurality of segments is concentric with a second group of segments in the plurality of segments relative to a center point and wherein the first group of segments is spaced from the center point a distance greater than the second group of segments.

15. The support of claim 14 wherein there are three groups of segments in the plurality of segments wherein each group of segments is a different distance from the center point relative to another group of segments.

16. The support of claim 3 wherein the first and second payload block portions are an elastomeric material.

17. A payload support comprising:
a first payload block portion having a first surface, and having a second surface configured to contact a first positioning element to help hold the first payload block portion in place;
a second payload block portion having a third surface configured to contact the first surface and having a fourth surface configured to contact a second positioning element to help hold the second payload block portion in place;
a plurality of removable segments in the first payload block portion configured such that removal of at least one of the segments forms an opening through the first payload block portion;
a plurality of removable segments in the second payload block portion configured such that removal of at least one of the segments forms an opening through the second payload block portion; and
wherein a first removable segment in the first payload block portion and a second removable segment in the second payload block portion are configured such that removal of the first removable segment defines a first opening and removal of the first and second removable segments defines a second merged opening larger than the first opening.

18. The support of claim 17 wherein the removable segments are arcuate.

19. The support of claim 17 wherein some of the removable segments in the first payload block portion are adjacent each other and wherein adjacent segments are connected.

20. The support of claim 19 wherein some of the removable segments in the second payload block portion are adjacent each other and wherein adjacent segments in the second payload block portion are connected.

21. The support of claim 17 wherein the removable segments are configured such that removal of two segments in the first payload block portion and removal of two segments in the second payload block portion form a substantially circular opening.

22. The support of claim 21 wherein the substantially circular opening is a first circular opening, and wherein the removable segments are configured such that removal of three segments in the first payload block portion and removal of three segments in the second payload block portion form a second substantially circular opening larger than the first circular opening.

23. A payload support comprising:
a first payload block portion having a first surface for receiving a holding element for helping to hold the first payload block portion in place and having a second surface facing at least partly away from the first surface and defining a first opening in the first payload block portion;
a second payload block portion having a third surface for contacting a holding element for helping to hold the second payload block portion in place and having a fourth surface facing at least partly away from the third surface and defining a second opening in the first payload block portion and wherein the first and second openings together define a merged opening when the first and second payload block portions are in contact with each other with the second and fourth surfaces facing each other;
a wall defining a first arcuate opening through the first payload block portion positioned between the first and second surfaces and separated from the second surface by a removable support material, and wherein the removable support material is configured such that removal of the removable support material allows formation of a third opening larger than the first opening; and
a wall defining a second arcuate opening through the second payload block portion positioned between the third and fourth surfaces and separated from the fourth surface by a removable support material.

24. The support of claim 23 wherein the removable support material in the second payload block portion is configured such that removal of the removable support material allows formation of a fourth opening larger than the second opening.

25. The support of claim 23 further including a plurality of walls defining respective arcuate openings in the first payload block portion concentric with the first arcuate opening and a plurality of walls defining respective arcuate openings in the second payload block portion concentric with the second arcuate opening, and wherein a first group of arcuate openings define parts of a first circle, and a second group of arcuate openings define parts of a second circle.

26. A method of changing a payload support comprising:
removing a payload from an opening in a payload support;
removing at least one pre-defined segment from the payload support to form an enlarged opening in the payload support; and
placing a payload in the enlarged opening.

27. The method of claim 26 wherein removing a segment includes removing an arcuate segment from the payload support.

28. The method of claim 27 wherein removing a segment includes removing two arcuate segments from the payload support to form a substantially circular enlarged opening in the payload support.

29. The method of claim 26 wherein the opening is circular and wherein removing at least one pre-defined segment includes removing at least one pre-defined segment to form an enlarged circular opening in the payload support.

30. The method of claim 26 wherein removing at least one pre-defined segment includes punching out the segment.

31. The method of claim 30 wherein punching out the segment includes punching out the segment with a tubular element.

32. The method of claim 26 further including moving a first payload support block prior to removing the payload from the opening.

33. The method of claim 32 wherein moving the first payload support block includes removing the first payload support block from a second payload support block.

34. A method for making a payload support comprising:
forming first and second block portions in such a way that the first and second block portions can be moved toward and away from each other and having a first side and a second side;
forming at least one opening in at least the first block portion in such a way that at least one segment is formed and positioned between the at least one opening and the second block portion; and
forming a payload opening between the at least one opening and the second block portion having a cross-sectional area sufficient to receive and support a payload.

35. The method of claim 34 further including forming first and second block portions to be separate structures.

36. The method of claim 34 further including forming the at least one opening in at least the first block portion in such a way that the at least one segment is arcuate.

37. The method of claim 36 further including forming at least two segments and removing the at least two segments.

38. The method of claim 34 further including forming at least a third opening in at least the second block portion in such a way that at least a second segment is formed and positioned between the third opening and the first block portion, and wherein forming a payload opening forms a first payload opening and further including removing the at least one segment and the second segment so as to substitute a second payload opening for the first payload opening larger than a size of the first payload opening.

39. The method of claim 38 wherein the at least first and second segments are formed to be arcuate.

40. The method of claim 38 wherein the at least first and second segments are formed so as to be concentric.

41. The method of claim 38 wherein forming the first payload opening includes forming a circular payload opening, and wherein forming the second payload opening includes forming a circular payload opening.

42. The method of claim 34 further including forming a plurality of openings in the first and second block portions in such a way that respective segments are formed and positioned in respective ones of the first and second block portions, and wherein the segments are configured in such a way that removal of one segment creates an opening through the payload support having a different size than an opening created by removal of another segment.

43. A method of assembling a payload onto a payload support comprising:
placing a payload support on a support structure wherein the payload support has a first opening;
securing the payload support to the support structure;
removing a segment from the payload support adjacent the first opening to form a second opening replacing and enlarging the first opening; and
placing a payload in the second opening.

44. The method of claim 43 wherein removing a segment includes removing an arcuate segment from the payload support.

45. The method of claim 43 wherein first and second segments are included on respective first and second payload support portions and wherein removing a segment from the payload support includes removing the first and second segments to form the second opening.

46. The method of claim 45 wherein the second opening is formed at least partially circular.

47. The method of claim 43 wherein first and second segments are included on the first payload support portion and third and fourth segments are included on the second payload support portion and wherein removing a segment from the payload support includes removing the first, second, third and fourth segments to form the second opening.

48. The method of claim 47 wherein removing the first, second, third and fourth segments form a substantially circular opening.

49. The method of claim 43 wherein placing a payload in the second opening includes placing a payload on a first payload support element and placing a second payload support element across the payload and against at least part of the first payload support element.

50. The method of claim 43 wherein securing the payload support includes releasably securing the payload support to the support structure.

51. The method of claim 43 wherein placing a payload support on the support structure includes placing a payload support on the support structure wherein the payload support has a first opening sized sufficient to support a payload, and second and third openings spaced from the first opening defining respective first and second removable segments.

52. The method of claim 51 wherein placing a payload support includes placing a payload support wherein the payload support has fourth and fifth openings spaced from the second and third openings defining respective third and fourth removable segments.

53. The method of claim 51 wherein removing a segment from the payload support includes removing the first and second removable segments.
